(19) United States
(12) Patent Application Publication
(10) Pub. No.: US 2006/0282893 A1
(43) Pub. Date: Dec. 14, 2006

(54) Network information security zone joint defense system

(75) Inventors: Wei-Ming Wu, Hsinchu (TW); Chun-Yu Yeh, Hsinchu (TW); Tse-En Shao, Hsinchu (TW); Pi-Fu Ko, Hsinchu (TW)

Correspondence Address: BACON & THOMAS, PLLC, 625 SLATERS LANE, FOURTH FLOOR, ALEXANDRIA, VA, 22314, US

(73) Assignee: D-Link Corporation, Hsinchu (TW)

(21) Appl. No.: 11/183,834

(22) Filed: Jul. 19, 2005

(30) Foreign Application Priority Data
Jun. 10, 2005 (TW) 094119203

(51) Int. Cl. G06F 15/16; G06F 12/14; G06F 17/00; G06F 11/00; G06F 9/00; G06F 12/16; G06F 15/18; G08B 23/00

(52) U.S. Cl. 726/23; 726/11; 726/13; 726/14

(57) ABSTRACT

A network information security zone joint defense system is provided, which monitors a network connection status through a network defense appliance. Once the network defense appliance detects a user computer in a network system triggering the conditions of a network zone joint defense, the network defense appliance immediately and automatically connects to a specified network switch, such that the network switch interrupts the network access service provided for the user computer, so as to effectively prevent virus or hacker from continuing spreading virus to the same or other subnet of the network, and further prevent the virus from starting a DDoS attack or paralyzing the network server, and thus greatly reducing the damages and losses to the network system.

### FIELD OF THE INVENTION

The present invention relates to a network information security mechanism, and more particularly to a network information security zone joint defense system having a network defense appliance for monitoring network connection statuses with user computers in a network and disconnecting network service of a user computer when the network defense appliance detects that the user computer has an abnormal behavior violating rules of network access service, so as to effectively prevent virus causing the abnormal behavior from being continuously spreading to the same or other subnets of the network.

### BACKGROUND OF THE INVENTION

Nowadays, with the rapid development of both Internet and e-commerce, people are very optimistic about the business opportunities brought by networks. However, people or enterprises have to face various potential threats of network securities, such as viruses spread, and invasions of hackers when they are heavily relying on network communication. For example, with the characteristics of the open system and convenient transmission of the Internet, the purposes of attacks made by some hackers are not for invading corporate computer systems to steal or alter website data, but for adopting a so-called distributed denial of service attack (abbreviated as DDoS attack) to send out a large quantity of packets with spoofed source IP addresses through several computers distributed at different locations. Thus, victim's network server is paralyzed not to provide the normal services due to normal logon rate dropped below 1%.

In order to paralyze one or more target websites, DDoS attackes simultaneously send out a massive quantity of data that is far beyond the network load or the attacked computers can handle, rather than terminate the system program of the attacked network server. That is, DDoS attacks involve simultaneously starting the Denial-of-Service (DoS) attacks on several sets of computers on the network through a network distributed source technique, such that the attacked network server has to face its enemies coming from several hundreds of computers via the network. Therefore, the DDOS attack needs a certain number of computers to act as daemons. The daemons will simultaneously aim at a target for starting a paralytic attack provided that a hacker sends out an attack command. Before secretly starting a DDoS attack, hackers have to illegally obtain passwords from specific computers through stealing or monitoring, and then take the control of the computers and make them to be masters. In the meantime, the hackers place an invaded backdoor program into the masters, and then start trying to invade a number of network computers through the backdoor program installed on the masters to obtain a sufficient number of computers to be the daemons. Finally, the hackers put an attack master program into the masters for ordering the daemons to start the DDOS attacks simultaneously, and also put an attack program into the daemons to execute the paralytic attack.

In general, the DDoS attack method primarily utilizes vulnerability on the request and response mode of the TCP/IP communication protocol to carry out the attack. In a typical network system, both parties in communication usually send out a request packet to the other party for assuring a proper connection for their communication, and wait for acquiring a correct response packet from the other party. A proper connection is ensured provided that the responding party sends a correct response packet in reply. For example, if party A is connected to communicate with party B in the TCP/IP communication protocol, then party A will send out a SYN packet to party B. Party B will reply a SYN-ACK packet to party A on condition that party B receives the request packet. Similarily, party A will send out an ACK packet to party B for confirmation. After such procedure is completed, the connection between parties A and B is ensured for data transmission. Under the communication mode aforementioned, a hacker may attempt to produce the amount of SYN packets to a specific computer on the network without returning the ACK packet to that computer, such that the attacked target computer or network will be slowed down or crashed since it can not handle the amount of junk packets produced or forged by the hacker.

To effectively prevent a DDoS attack, system administrators must find the network computer installed with a permanent residing attack program before they can resolve the threat of DDOS attacks. At present, there are many tools for detecting the permanent residing attack programs. For example, in a Windows operating system, the Internet Scanner 6.01 program and the RealSecure 3.2.1 of IIS may be used for scanning, wherein the former can scan, for example, the TribeFlood Network's permanent residing attack program and help finding the vulnerability of the website to prevent the website to become an accessory for hackers to carry out the DDOS attack, and the later may detect the communication between the master and daemon of the DDoS and thus effectively prevent a hacker to start the DDOS attack. In addition, the British NIPC also developed a program to discover a DDoS attack, and such program allows system administrators to test their systems and check whether or not a program similar to the DDOS attack program is installed. At last, the system administrators can monitor their computers or routers and eliminate any abnormal packets with spoofed source IP addresses, such as 10.0.0.0/8, 172.16.0.0/12 and 192.168.0.0/16, or close all service ports that are not required by the network computer. In the meantime, the system administrator also may set up a logon list on the network computer or the router to prevent invasions. However, most system administrators are unable to guard their systems by reason of attacks started internally. The only thing the system administrator can do is to take remedial actions after the occurrence of attacks. However, it will be too late. Actually, a network security mechanism is established for automatically discovering and stopping any abnormal network operation by an automatic mechanism to effectively and timely avoid any malicious attacks or serious damages that may paralyze the network. For example, the system administrator may set up a blacklist for the network access and service. At present, there are many network appliances such as switches and network security means including firewalls and the like that provides a mechanism to monitor the network flow and control the network access. However, these monitor appliances lack of an interactive mechanism, and cannot be connected in time to the system and thus unable to effectively prevent malicious attacks to the network.

Nowadays, the network connection control and management technology only aims at the abnormal packet or the connection violating the network policy to deny service when the packet passes through the network security appliances, but it cannot detect the flow that does not pass through the network security appliance, and cannot effectively deny the network connection of the user computer. If continuous or amount network attacks or abnormal network accesses are encountered, the network administrator will keep on processing the denied network accesses and services and will become very busy. Furthermore, the network administrator may pay little attention to effectively and timely taking care of the malicious attacks to the network. Therefore, one approach is to connect a network switch through a network management computer, and manually change the settings of the switch to disconnect the network of the user computer. Such arrangement cannot effectively and timely provide an active protection function, and usually ends up with a serious damage. Referring to FIG. 1 for an example, a traditional Internet includes a network management computer 11, a network defense appliance 20, a plurality of network switch 30, 31, 40, 41 for different network sections A, B, C, a plurality of servers 50 connected to the network defense appliance 20, and a plurality of user computers 10, 12 connected to the network switch 31. In summation of the description above, the network system will take the following actions and method when it encounters a virus attack:

(1) A user computer 10 (with an IP address 192.168.1.2) is infected by a WORM virus (WORM_MSBLAST.A) and starts sending out the amount of TCP SYN (DST port: 135) packets and scans all computers on the network that are installed with a Windows operating system, and then spreads the virus to those computers through the vulnerability of RPC DCOM Overflow in the Windows operating system.

(2) If the TCP SYN (DST port: 135) packets pass through a network defense appliance 20 and the network administrator has completed the security setup on the network defense appliance 20, then the TCP SYN (DST port: 135) packets will be blocked successfully, and the packets will not be distributed to the subnets B and C of the network. If the network administrator has started appropriate warning and record setup for the network defense appliance 20, then the network administrator has to logon the network defense appliance 20 again to check the Log record for analyzing the computers if there is any abnormal behavior of the user computer such as sending out a large quantity of TCP SYN (DST port: 135) packets.

(3) Since the network switches 30, 31 as shown in FIG. 1 belong to the same subnet A of the network, the network defense appliance 20 cannot issue the TCP SYN(DST port: 135) packets from the computer in the same subnet of the network to achieve the blocking, therefore the subnet A of the network is connected to the network switches 30, 31 and has the same vulnerability to other user computers 12 which will be affected by the virus and DDOS attack.

(4) Therefore, the network administrator has to use a network management computer 11 to complete the warning analysis and process record as described in Step (2) to make sure that the attacked computer 10 is connected to the network through the network switch 31, and then the network management computer 11 is connected to the network switch 31 to set the denial-to-service network for the computer 10. However, it takes a long time for completing the whole denial-to-service setup, and the virus may already spread to other computers on the subnets A, B and C of the network.

In view of the description above, the traditional network defense appliances lack of an interactive mechanism, and thus cannot timely connect with each other to effectively prevent a malicious attack to the network. It is an important subject for network companies to find a way to integrate the network defense appliances, such that when a user computer discovers any abnormal network, the user computer can timely disconnect the source and interrupt the network connection service of the user computer, so as to avoid further affections of the virus to the same subnet or other subnet of the network as well as preventing a start of the DDOS attack that will paralyze the network server.

### SUMMARY OF THE INVENTION

In view of the prior art network connection control technology only aiming at the abnormal packet or denial-to-service setup for the network flow that violates the network policy, but it is incapable of automatically and timely disconnecting the abnormal network according to the source, the inventor of the present invention based on years of experience in the development of network appliances and systems to conduct extensive researches and experiments according to the characteristics and methods of spreading the virus and paralyzing the website, and finally developed a network information security zone joint defense system in accordance with the present invention.

Therefore, one of objectives of the invention is to detect a network connection status through a network defense appliance. Once the network defense appliance detects any user computer in the network that has an abnormal behavior violating the rules of the network access service, the network defense appliance immediately preventing the abnormal connection by automatically connecting to the network switch providing the network connections for the user computers, commanding the network switch to disconnect the network connection of the user computer and quickly denying services to the user computer sending malicious packets or violating the policy of network access, so as to effectively prevent virus or hacker from continuing spreading the virus to the same or other subnets of the network, and further prevent the virus from starting a DDOS attack or paralyzing the network server, and thus greatly reducing the damages and losses to the network system.

Another one of objectives of the present invention is to provide a network defense appliance that sends an interruption command according to at least one critical condition, and the network administrator needs not to waste time on finding the infected computer. After locating the infected computer, the network administrator needs not to manually apply a denial-to-service command to disconnect the network connection of the infected computer as well as its connected network switches, and thus greatly reducing the manpower and time required for network management.

A further objective of the present invention is to use the Simple Network Management Protocol (SNMP) to add a new function to the network defense appliance and define the conditions for starting the network zone joint defense by the network administrator. Once a user computer issues packets of a flow that triggers such conditions, the network defense appliance uses the SNMP to send a denial-to-service command to the network switch, so that after the network switch has received the network denial-to-service command, the setup for the network denial-to-service command is completed at once, so as to interrupt the network access service of the user computer, and reply a response packet to the network defense appliance to confirm the successful interrupt of the network access service provided by the network switch of the user computer.

The above and other objects, features and advantages of the present invention will become apparent from the following detailed description taken with the accompanying drawings.

### BRIEF DESCRIPTION OF THE DRAWINGS

FIG. 1 is a schematic view of the connection of a prior art network system;

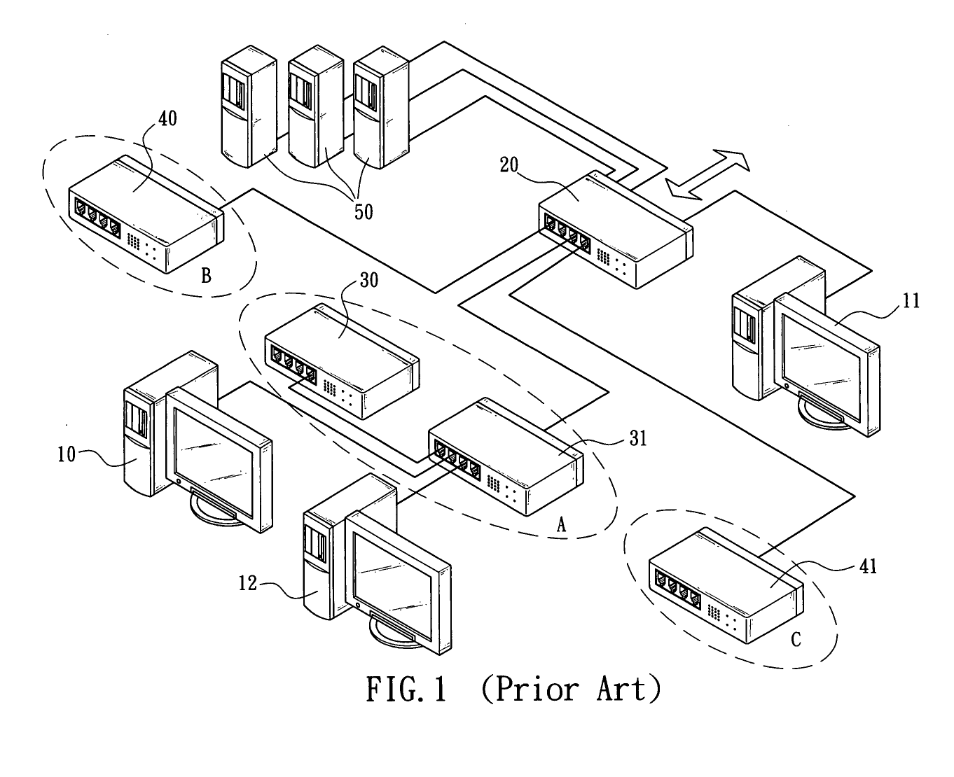

FIG. 2 is a flow chart of a network defense appliance according to a preferred embodiment of the invention; and

FIG. 3 is a schematic view of the connection of a network system according to a preferred embodiment of the invention.

### DETAILED DESCRIPTION OF THE PREFERRED EMBODIMENTS

The present invention relates to a zone joint defense system of network information security, which uses a simple network management protocol (SNMP) to monitor a network connection status of a network defense appliance, such as a firewall, a bandwidth manager, an intrusion defense system (IDS) or a flow analyzer, to add a function and define the conditions of starting a zone joint defense required by the network administrator for the network. Once one of the conditions at least is triggered by, for example, the amount of the packets sent by a user computer, the network defense appliance would immediately and automatically connect to one or more network switches and the SNMP will be used to send a denial-to-service command to the network switch, so as to immediately complete the interrupt setup for the network access service of the user computer after the network switch has received the denial-to-service command, interrupt the network access service of the user computer, and effectively prevent the virus from spreading to other subnets of the network. Such arrangement further prevents the virus from starting the DDoS attack or paralyzing the network server to minimize the damages and losses to the network system. In the meantime, the network switch replies a response packet to the network defense appliance to confirm a successful interrupt of the network access service provided by the network switch of the user computer.

It is noted that the use of SNMP in defining the rules and producing interrupting command is advantageous and preferred in the present invention, since SNMP belongs to one kind of transmission control protocol/internet protocol (TCP/IP) and has been widely used in and supported by the various network devices or systems nowadays, such as firewalls, bandwidth managers, intrusion defense systems and flow analyzers, etc. With the use of SNMP, the zone joint defense system of the present invention is easily applied to the existed network devices and systems without modifying hardware or considering compatibility. However, the utility of SNMP is not a limitation on the present invention. Numerous modifications and variations could be made thereto by those skilled in the art without departing from the scope and spirit of the invention set forth in the claims.

Further, the reasons herein causing the aforementioned user computers having abnormal conducts generally refer to the various abnormal behaviors unobservable by users, unallowable by the users, threatening or paralyzing the normal operations of the network communication of the user computer, or caused by various hackers or viruses, but the spirit of the invention is not limited to those. In addition, the attack and threat would be various forms such as buffer overflow attacks, port scan attacks, Trojan Horse attacks, an IP fragmentation attacks, a worm attacks or system & application vulnerabilities attacks. Thus, the abnormal behaviors are not limited to the foregoing DDoS attacks only.

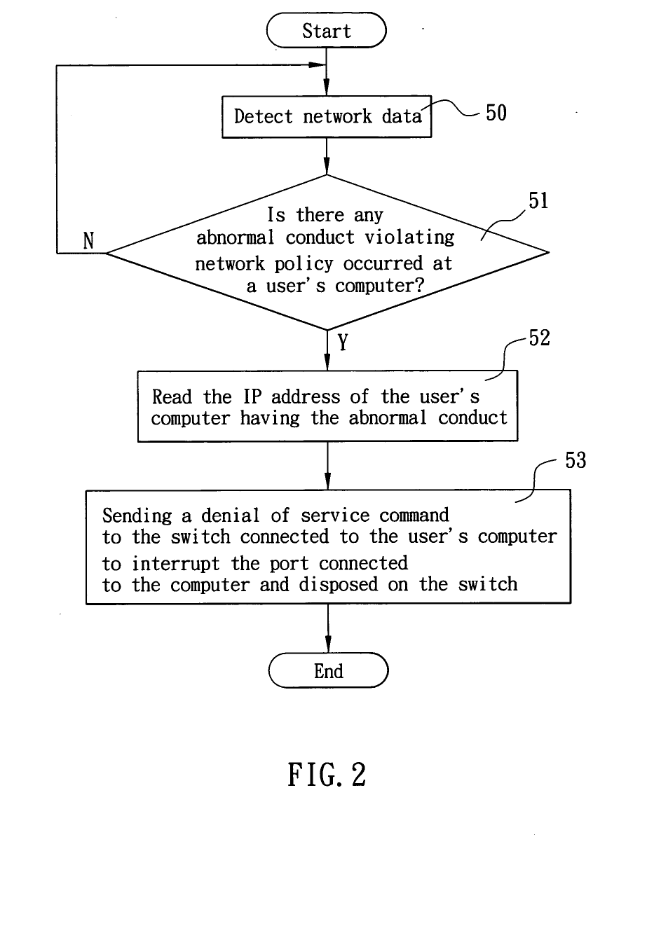

When the system of the present invention is implemented, an additional function in the network defense appliance of the network system enables a network administrator to define the conditions of starting the network zone joint defense. Thus, depicted as FIG. 2, the network defense appliance carries out the following procedure for detecting the violation of the network access service rule or the trigger of the conditions of the network zone joint defense by one or more user computers and further interrupting the network access services. The process includes the steps of:

Step (50) detecting the packet data passing through the network defense appliance;

Step (51) analyzing the detected packet data to determine whether or not any of the user computers triggers the conditions of the network zone joint defense, such as reaching a predetermined critical condition, including but not limited to, a packet quantity or a bandwidth; if yes, then going to the next step, or else returning to Step (50);

Step (52) reading out the IP address of the user computer that triggers the network zone joint defense or violates the network access service rule;

Step (53) using the SNMP to send a network denial-to-service command to one or more network switches, once the network switch receives the network denial-to-service command, the network switch set for interrupting the network access service of the user computer and then blocks the network access service for the user computer to effectively prevent the virus from spreading to other subnets of the network.

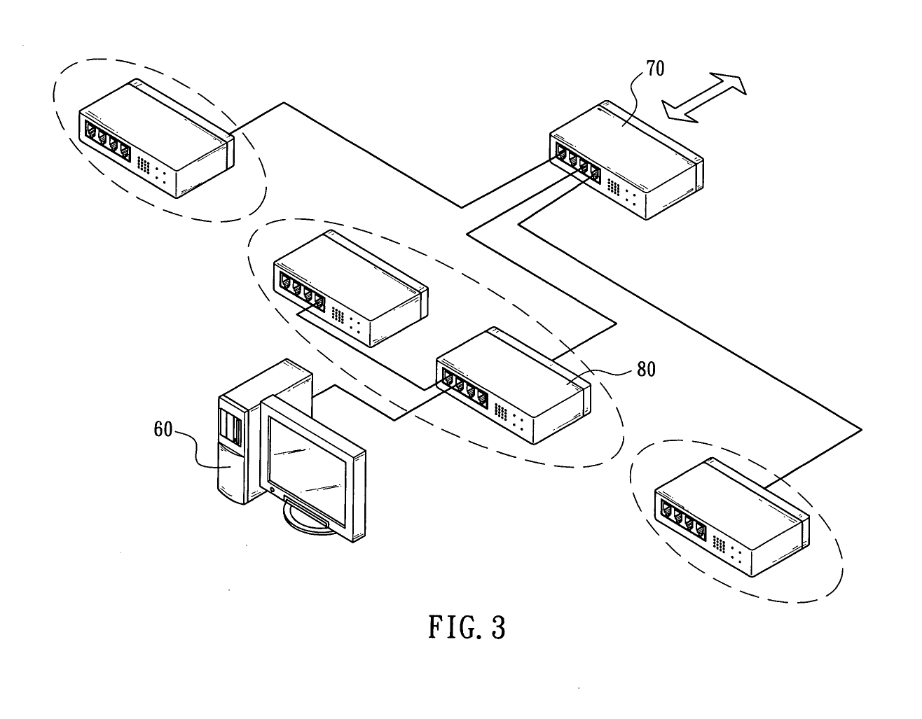

To describe the design concept and performance of the present invention, a preferred embodiment as shown in FIG. 3 is used for illustration. Once the network system is infected by a virus, the network information security zone joint defense system of the present invention carries out the following procedure:

(1) In a network system, an user computer 60 with the IP address 192.168.1.2 is infected by a worm virus (WORM_MSBLAST.A) and starts sending out a large quantity of TCP SYN (DST port: 135) packets. After the other computers installed with the Windows operating system and connected to the network are scanned, the virus spreads and launches the DDOS attack through the vulnerability of the RPC DCOM Overflow in the Windows operating system.

(2) When the TCP SYN (DST port: 135) packets pass through a network defense appliance 70 in which the conditions of triggering network zone joint defense are preset or pre-defined, such as preventing IDS attacks, Http/Ftp address or flow limit, user network connection number limit, etc., the network defense appliance 70 continues monitoring the flow of network packets and further analyzes whether or not the user computer executes any abnormal transmission of a large quantity of TCP SYN(DST port: 135) packets.

(3) If the network defense appliance 70 detects an abnormal behavior of a user computer 60, such as sending out a large quantity of TCP SYN(DST port: 135) packets, it would read out the IP address of the user computer 60 violating the network access service rule and, according to the IP address of the user computer 60, automatically connects to the network switch 80 or other pre-defined/assigned network switches to send a network denial-to-service command (such as deny (192.168.1.2) any TCP 137)).

(4) The network switch 80 sets an interruption in. relation to the network denial-to-service command and then immediately interrupts the network access service for the user computer 60, such that the user computer 60 with an IP address 192.168.1.2 is blocked in the shortest possible time to prevent the network packets from entering the whole network. Accordingly,. the virus is effectively kept from spreading all over other user computers (not shown in the figure) in the same subnet of the network, other user computers on the switching appliance of the same subnet, or other user computers (not shown in the figure) of other subnets of the network.

In the aforementioned preferred embodiment, not limited to, the IP address of the network defense appliance 70 may be assigned 192.168.1.1 and the IP address of the network switch 80 is 192.168.1.250. Once the network defense appliance 70 detects that the user computer 60 sends out a large quantity of TCP SYN(DST port: 135) abnormal packets, it may send out a set request including the following contents through the SNMP according to the IP address of the user computer to inform the network switch 80 to interrupt the access service of the network for the user computer 60 having an IP address 192.168.1.2:

IP: Source address=[192.168.1.1]

IP: Destination address=[192.168.1.250]

SNMP: Command=Set request

SNMP : Object={1.3.6.1.4.1.171.12.9.2.2.1.4.2.1}

SNMP: Value=[192.168.1.2]-

where, the network switch 80 is a switch produced by D-Link Company (D-Link is a trademark of D-Link Corporation), and its MIB object 171.12.9.2.2.1.4.2.1 is an access control list (ACL) acceptable by the appliance (such MIB parameter varies according to the model and brand of the switch), and the system number is 9.2.2.1.4.2.1. The-network defense appliance 70 sends a command for interrupting the network access service of the user computer 60 having an IP address 192.168.1.2 to the MIB address in the D-Link switch through the SNMP.

After the network switch 80 has received the network denial-to-service command and the setup is completed, the network switch 80 replies a response packet (Get response) including the following contents to the network defense appliance 70 to inform the network defense appliance 70 that the network access service of the user computer 60 with an IP address 192.168.1.2 in the network switch 80 is blocked successfully:

IP: Source address=[192.168.1.250]

IP: Destination address=[192.168.1.1]

SNMP: Command=Get response

SNMP: Object={1.3.6.1.4.1.171.12.9.2.2.1.4.2.1}

SNMP: Value=[192.168.1.2]

In view of the above description, the present invention drives a network defense appliance in the network system to automatically detect the network packets passing therethrough. If the amount or flow of packets of a user computer triggers a network zone joint defense, then a network denial-to-service command is sent automatically to a specified network switch and/or other switches to immediately interrupt the network connection of the user computer, and rapidly block the normal network connection and thus greatly reducing the damages and losses caused by the abnormal behaviors to the network system, so as to effectively enhance the network performance. Accordingly, it is not necessary for the network administrator to waste time to find out the infected computer. Furthermore, it is also not necessary for the network administrator to manually issue a network denial-to-service command to the infected computer. Accordingly, the network service at the edge of the network (which is also the source closest to the infected computer) is interrupted to greatly reduce the manpower and time required for the network management.

While the invention herein disclosed has been described by means of specific embodiments, numerous modifications and variations could be made thereto by those skilled in the art without departing from the scope and spirit of the invention set forth in the claims.

What is claimed is:

1. A network information security zone joint defense system monitoring the connection status of a network system by a network defense appliance, and once said network defense appliance detects a user computer in said network system triggering the condition of a network zone joint defense, said network defense appliance immediately and automatically connects to a specified network switch, such that said specified network switch interrupts a network access service provided for said user computer.

2. The system of claim 1, wherein said network defense appliance is a firewall, a bandwidth manager, an intrusion defense system, or a flow analyzer.

3. The system of claim 2, wherein said network defense appliance includes a mechanism for defining the rules of said network access service permitted by a network administrator and the conditions of triggering said network zone joint defense.

4. The system of claim 1, wherein, when said network defense appliance detects an abnormal conduct of said user computer in said network system that violates a network access service rule, said system immediately and automatically connects said network defense appliance with said specified network switch and enables said specified network switch to interrupt said network access service provided for said user computer.

5. The system of claim 1, wherein said network defense appliance uses a simple network management protocol (SNMP) to send a denial-to-service command to said specified network switch for interrupting said network access service provided for said user computer.

6. The system of claim 5, wherein once said specified network switch receives said network denial-to-service command, said specified network switch sets an interruption and then blocks said network access service provided by said network switch according to said interruption.

7. A method for controlling a network service, comprising the steps of:
detecting a packet data derived from a user computer;
determining whether or not said packet data complies with at least one of network service rules; and
sending an interrupt command to a specified switching appliance to execute said interrupt command for stopping transmitting said packet data of said user computer on condition that said packet data of said user computer complies with at least one of network service rules.

8. The method for controlling a network service of claim 7, wherein said sending step further comprises using a simple network management protocol (SNMP) to send said interrupt command.

9. The method for controlling a network service of claim 7, further comprising presetting said network service rules.

10. The method for controlling a network service of claim 9, wherein said determining step further comprises comparing a packet quantity of said packet data of said user computer with said network service rule.

11. The method for controlling a network service of claim 7, further comprising presetting said specified switching appliance.

12. A network security defense appliance, comprising:
setup means for setting at least one of network service rules and at least one of specified switching appliances;
defense means for detecting packet data of a user computer;
analysis means for comparing said network service rule with said packet data of said user computer; and
security means for sending an interrupt command driven by a comparison result, and said interrupt command is executed by said specified switching appliance to block the transmission of said packet data of said user computer.

13. The network security defense appliance of claim 12, wherein said security means uses a simple network management protocol (SNMP) to send said interrupt command.

14. The network security defense appliance of claim 12, wherein said defense means is a firewall, a bandwidth manager, an intrusion defense system, or a flow analyzer.

15. The network security defense appliance of claim 12, wherein said analysis means includes a mechanism for defining the rules of said network access service permitted by said network administrator and the conditions of triggering said network zone joint defense.
